(19) United States
(12) Patent Application Publication
(10) Pub. No.: US 2026/0080475 A1
(43) Pub. Date: Mar. 19, 2026

(54) SIMPLIFIED, BEHAVIOR-MODIFYING, PERSONAL BUDGETING AND FINANCIAL MANAGEMENT TOOL

(71) Applicants: Kevin M. Ashton, Lindon, UT (US); Jens K. Ashton, Provo, UT (US)

(72) Inventors: Kevin M. Ashton, Lindon, UT (US); Jens K. Ashton, Provo, UT (US)

(21) Appl. No.: 18/888,172

(22) Filed: Sep. 18, 2024

(51) Int. Cl. G06Q 40/06; G06F 3/0486

(52) U.S. Cl. CPC G06Q 40/06; G06F 3/0486; G06Q 40/065

(57) ABSTRACT

A method to assist an individual or family in managing finances is disclosed. In one embodiment, such a method includes documenting financial transactions associated with a user. The method establishes multiple budget categories to which the financial transactions may be assigned and represents, on a graphical user interface, the financial transactions as cards that are draggable by the user in a desired direction. The method represents, on the graphical user interface, the budget categories as virtual pouches and enables the user to drag the cards into the virtual pouches to assign the associated financial transactions to the associated budget categories. In certain embodiments, the virtual pouches include primary pouches including a first primary pouch configured to receive cards documenting fixed recurring expenses, and a second primary pouch configured to receive cards documenting variable non-recurring expenses. A corresponding system and computer program product are also disclosed herein.

### BACKGROUND

### Field of the Invention

This invention relates to systems and methods for assisting individuals and families in managing their finances.

### Background of the Invention

Budgeting software tools are valuable resources for individuals and households seeking to manage their finances. These tools may streamline the budgeting process by offering user-friendly interfaces that enable users to track income, expenses, and savings goals in real-time. By categorizing transactions automatically and providing customizable budget templates, these tools may provide an overview of financial health and spending habits. Moreover, they often include synchronization capabilities with bank accounts and credit cards, ensuring that financial data is up-to-date and easily accessible. Beyond day-to-day budgeting, these tools may provide insights through graphical representations and reports, enabling users to identify trends, make informed financial decisions, and adjust spending behaviors accordingly.

Despite their benefits, many budgeting software tools may be complex, which may cause burnout and deter users from fully utilizing them. The initial setup and customization of these tools may require time and effort, especially for individuals who are not familiar with financial terminology or software interfaces. Users may feel overwhelmed by the array of features and options available, as well as the number of budget categories, leading to uncertainty about where to start or how to effectively integrate the tool into their daily financial management routine. Unfortunately, the complexity of these tools may lead individuals and/or families to forgo using them, thereby undermining their potential benefits.

### SUMMARY

The invention has been developed in response to the present state of the art and, in particular, in response to the problems and needs in the art that have not yet been fully solved by currently available apparatus and methods. Accordingly, apparatus and methods in accordance with the invention have been developed to assist an individual or family in managing finances. The features and advantages of the invention will become more fully apparent from the following description and appended claims, or may be learned by practice of the invention as set forth hereinafter.

Consistent with the foregoing, a method to assist an individual or family in managing finances is disclosed. In one embodiment, such a method includes documenting financial transactions associated with a user. The method establishes multiple budget categories to which the financial transactions may be assigned and represents, on a graphical user interface, the financial transactions as cards that are draggable by the user in a desired direction. The method represents, on the graphical user interface, the budget categories as virtual pouches and enables the user to drag the cards into the virtual pouches to assign the associated financial transactions to the associated budget categories. In certain embodiments, the virtual pouches include primary pouches including a first primary pouch configured to receive cards documenting fixed recurring expenses, and a second primary pouch configured to receive cards documenting variable non-recurring expenses.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing a financial management module and various associated sub-modules to assist an individual or family in managing finances;

FIG. 3 shows one example of a graphical user interface of the financial management module that shows transactions represented as cards that are draggable into various pouches;

FIG. 4 shows one example of a card for a recurring expense that is draggable into a primary pouch, namely a “bills” pouch;

FIG. 5 shows one example of a card for a non-recurring expense that is draggable into a primary pouch, namely a “wallet” pouch;

FIG. 6 shows functionality to tag cards that are dragged into a pouch;

FIG. 7 shows functionality to drag cards into various secondary pouches;

FIG. 8 shows an exemplary list of various secondary pouches;

FIG. 9 shows one example of a card representing income for placement in the pouches;

FIG. 10 shows one example of a graphical user interface for an income splitter to divide up income between various pouches;

FIG. 11 is a continuation of the income splitter illustrated in FIG. 10;

FIG. 12 shows an example of a graphical user interface for displaying a user's net worth as well as a way to designate “daily cash” for placement in the user's “wallet”;

FIG. 13 shows an example of a graphical user interface for displaying a user's recurring expenses;

FIG. 14 shows an example of a card representing “daily cash” that is draggable into the user's wallet;

FIG. 15 shows one example of a screen that may be displayed once a user has addressed or allocated all of the cards in the stack;

FIG. 16 shows one example of a screen that may be displayed once a user has addressed or allocated all of the cards in the stack;

FIG. 17 shows one example of a screen that may be used to reconcile amounts listed in the user's pouches with amounts in the user's accounts;

FIG. 18 shows an example of a card representing a posted transaction that is used to reconcile an amount of a previous pending transaction;

FIG. 19 shows an example of a card representing a ghost transaction;

FIG. 20 shows one example of a screen that may be displayed to assist a user in accelerating reaching the user's goals;

FIG. 21 shows one example of a card that may be displayed to assist a user in liberating the user from use of a credit instrument such as a credit card;

FIG. 22 shows one example of a card that may be displayed when multiple users are not aligned in how they categorize a particular expense; and

FIG. 23 shows one example of a card that may be displayed when multiple users are aligned in how they categorize a particular expense.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

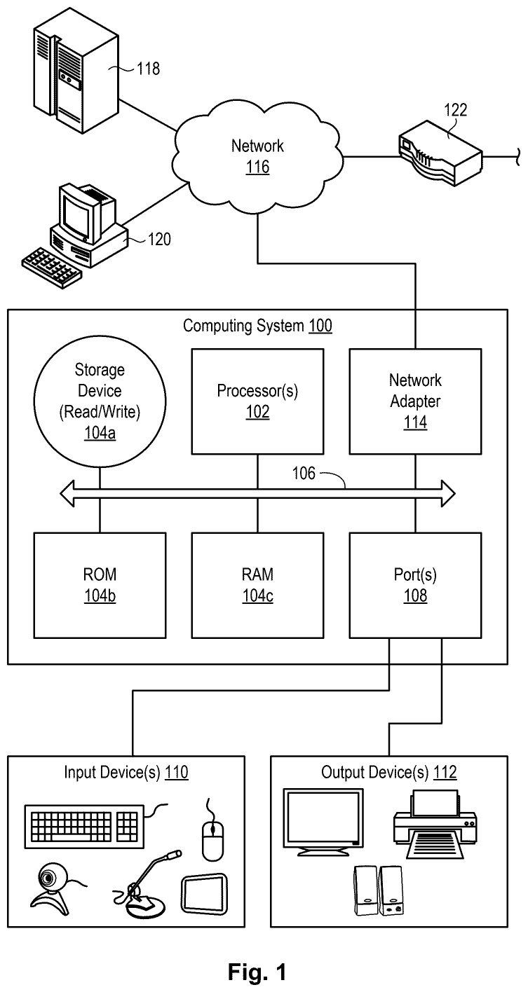

Referring to FIG. 1, one example of a computing system 100 is illustrated. The computing system 100 is presented to show one example of an environment where a financial management module 200 in accordance with the invention may be implemented. The computing system 100 may be embodied as a desktop computer, a workstation, a laptop computer, a server, a storage controller, a mobile device 100 such as a smart phone or tablet, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

As previously mentioned, budgeting software tools may be valuable resources for individuals and households seeking to manage their finances. These tools may streamline the budgeting process by offering user-friendly interfaces that enable users to track income, expenses, and savings goals. By categorizing transactions automatically and providing customizable budget templates, these tools may provide an overview of financial health and spending habits. Moreover, they often include synchronization capabilities with bank accounts and credit cards, ensuring that financial data is up-to-date and easily accessible. Beyond day-to-day budgeting, these tools may provide insights through graphical representations and reports, enabling users to identify trends, make informed financial decisions, and adjust spending behaviors accordingly.

However, despite their various perceived benefits, many budgeting software tools may be complex which may deter users from fully utilizing them. The initial setup and customization of these tools may require time and effort, especially for individuals who are not familiar with financial terminology or software interfaces. Users may feel overwhelmed by the array of features and options available, as well as the number of budget categories to which transactions may be assigned, leading to uncertainty about where to start or how to effectively integrate the tool into their daily financial management routine. Unfortunately, the complexity of these tools may lead individuals and/or families to forgo using them altogether, thereby significantly undermining their benefits.

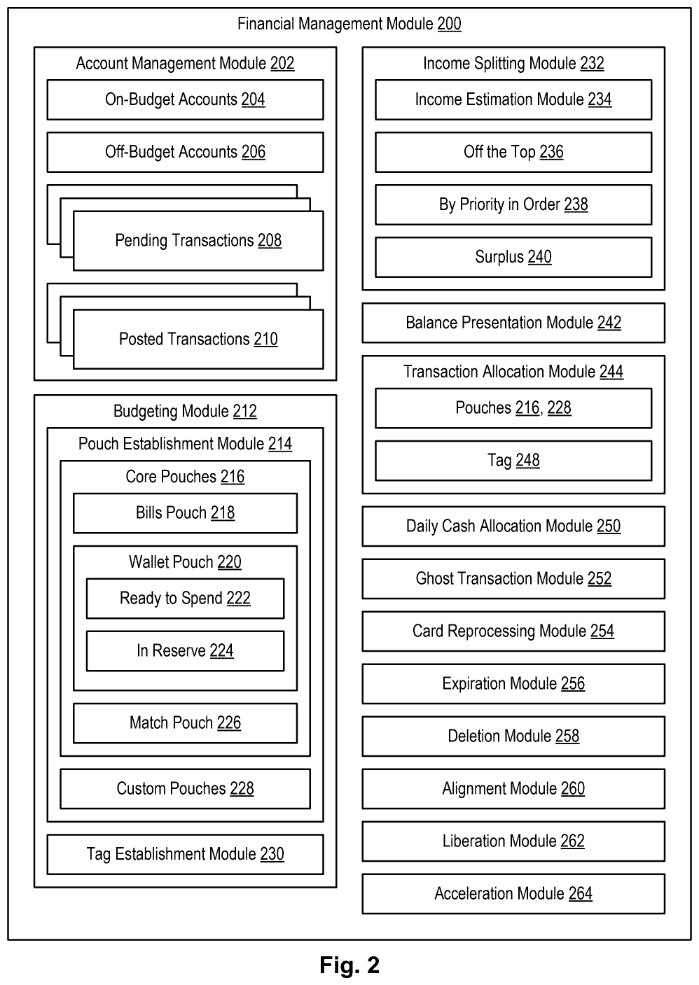

Referring to FIG. 2, a high-level block diagram showing a financial management module 200 and associated sub-modules is illustrated. The financial management module 200 and associated sub-modules may be implemented in hardware, software, firmware, or combinations thereof. The financial management module 200 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, the financial management module 200 may include one or more of an account management module 202, budgeting module 212, income splitting module 232, balance presentation module 242, transaction allocation module 244, daily cash allocation module 250, ghost transaction module 252, card reprocessing module 254, expiration module 256, deletion module 258, alignment module 260, liberation module 262, and acceleration module 264. The budgeting module 212 may include a pouch establishment module 214 and a tag establishment module 230.

The account management module 202 may be configured to manage accounts of the user held by financial institutions, such as checking accounts, savings accounts, credit card accounts, etc. In certain embodiments, the account management module 202 accesses the user's account information by way of application programming interfaces (APIs) provided by the user's financial institutions. Such APIs may enable the account management module 202 to access transaction histories, account balances, and other financial information. In certain embodiments, this may require users to authenticate and grant permission to the financial management module 200 to access their data. This represents just one method or technique that may be used by the account management module 202 to access a user's accounts and financial information and is not intended to be limiting.

In certain embodiments, the accounts accessed and managed by the account management module 202 include on-budget accounts 204 and off-budget accounts 206. For the purpose of this disclosure, on-budget accounts 204 may include accounts that are part of a user's budget. These accounts typically include cash accounts (i.e., savings and checking) and short term debt accounts such as credit card accounts. On-budget accounts 204 typically have balances that do not significantly fluctuate day to day (such as investment accounts).

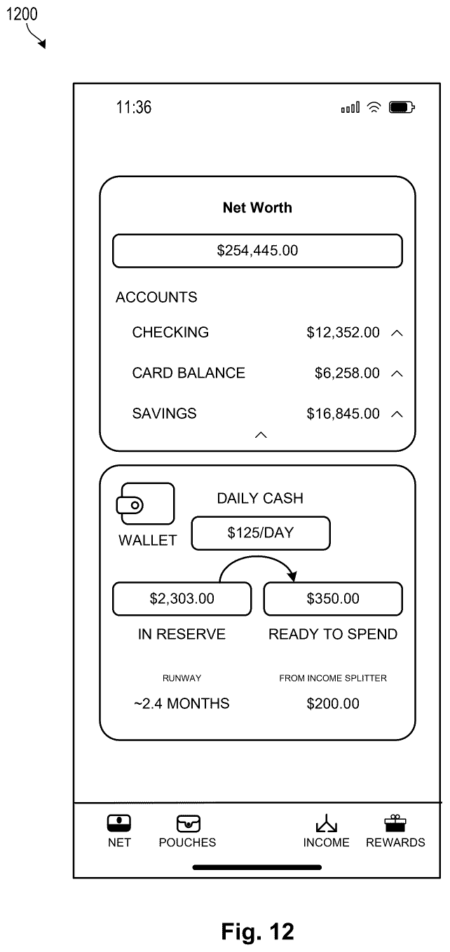

Off-budget accounts 206, by contrast, may include accounts that are not part of a user's budget. These may include accounts such as investment accounts, retirement accounts (e.g., 401k, IRA, etc.), loans, and the like. These accounts may be included as part of a user's net worth but not the user's budget as will be explained in more detail in association with FIG. 12.

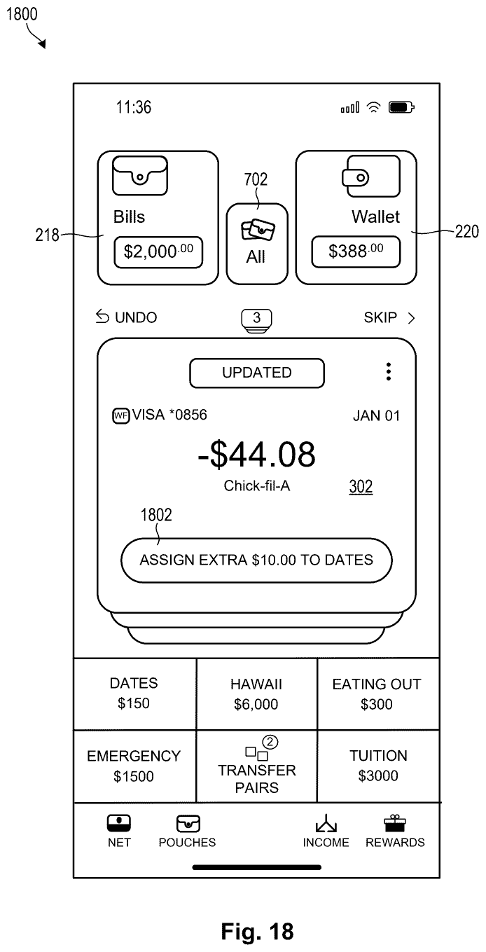

In certain embodiments, when accessing a user's accounts, the account management module 202 may access a user's pending transactions 208 as well as posted transactions 210. “Pending” means a transaction has been initiated but not yet finalized. “Posted” means the transaction has been completed and the funds have been fully transferred or debited. As will be explained in more detail hereafter, in certain embodiments, the financial management module 200 may work with “pending” transactions since these are available earlier than “posted” transactions. In the event a “posted” transaction differs in amount from its corresponding “pending” transaction when the transaction is finalized, the financial management module 200 may be configured to enable a user to make adjustments to the user's budget/finances based on the amount of the “posted” transaction. One example of this will be explained in more detail in association with FIG. 18.

The budgeting module 212 may be configured to establish a user's budget. In general, a budget may be defined as a tool to assist a user in pacing spending and achieving the user's financial goals. For this disclosure, the budget may be thought of as including pouches 216, 228 and on-budget accounts 204. For the purpose of this disclosure, a “pouch” is a base unit that makes up a user's budget. Pouches 216, 228 typically have positive values (i.e., balances) but can also be negative if the pouches 216, 228 are overdrawn, indicating that more money has been spent or withdrawn than is available in the pouch. The sum of the balances in the user's pouches 216, 228 should equal the sum of the balances of the user's on-budget accounts 204, which means that the sum of the balances in the pouches 216, 228 should be an accurate representation of the amount of money that the user possesses in the user's on-budget accounts 204.

As shown in FIG. 2, the pouches 216, 228 may include core (i.e., primary) pouches 216 and custom (i.e., secondary) pouches 228. The core pouches 216 may include pouches with special behaviors that significantly simplify and reduce effort needed by the user to manage the user's money. The core pouches 216 may in certain embodiments include a bills pouch 218, a wallet pouch 220, and a match pouch 226.

The bills pouch 218 may be used for recurring bills or expenses. The amount of money the bills pouch 218 may receive each month for paying these recurring bills or expenses may be estimated by the income splitting module 232, as will be discussed in more detail hereafter. In certain embodiments, the bills pouch 218 (as well as other pouches) may include sub-pouches that define different categories within the bills pouch 218 at a more granular level. In certain embodiments, large, less frequently recurring bills may be allocated to a custom pouch 228. For example, a recurring annual bill over $100 may be a good candidate for a custom pouch 228. This may be done to keep a month-to-month balance in the bills pouch 218 more predictable and to ensure that a really large bill doesn't exhaust the balance in the bills pouch 218.

The wallet pouch 220 may be used for day-to-day (i.e., non-recurring) living expenses. For example, the wallet pouch 220 may be used for expenses such as groceries, transportation, entertainment, eating out, and any other expenses that are part of daily life with a variability deemed to be non-recurring. In certain embodiments, the wallet pouch 220 is divided into two portions, namely a “ready to spend” portion 222 and an “in reserve” portion 224. When money is transferred into the wallet pouch 220, such as when a user receives a paycheck or other income, it may initially go into the “in reserve” portion 224 of the wallet pouch 220. In order to pace spending from the wallet pouch 220 in a way that allows the user's income to be evenly distributed over a period of time, some defined portion of the money in the “in reserve” portion 224 may be periodically transferred to the “ready to spend” portion 222 of the wallet pouch 220. For example, in certain embodiments, a daily cash allotment (also referred to hereinafter as “daily cash”) may be transferred from the “in reserve” portion 224 to the “ready to spend” portion 222 to provide for the user's daily expenses. This may assist a user to not overspend.

The match pouch 226 may serve as a matching ground for transactions that cancel each other out. In the context of a budget, this may occur when money is transferred between two bank accounts that are both on-budget accounts 204. For example, when a user transfers money from a saving account to a checking account the total amount of money in the user's budget and on-budget accounts 204 has not actually changed. Hence, there is no adjustment needed for the amounts in the user's pouches 216, 228. Another example is when a user utilizes a credit card. That is, a user may utilize a credit card to pay an expense and then pay off the credit card with money that is in the user's checking and/or savings account. The match pouch 226 may serve to match these transactions that cancel each other out so that the user's budget and balances in the pouches 216, 228 are not altered.

In certain cases, it may take several days before a match is found for a transaction in the match pouch 226. For example, a checking account can show an outflow several days before its corresponding transaction shows up on the user's credit card. When a transaction is added to the match pouch 226, the financial management module 200 may in certain embodiments expect a corresponding match to be found within a reasonable time period, such as a few days. This typically occurs when a normal expense transaction is assigned to the match pouch 226. Unmatched items in the match pouch 226 may eventually generate a match warning to the user.

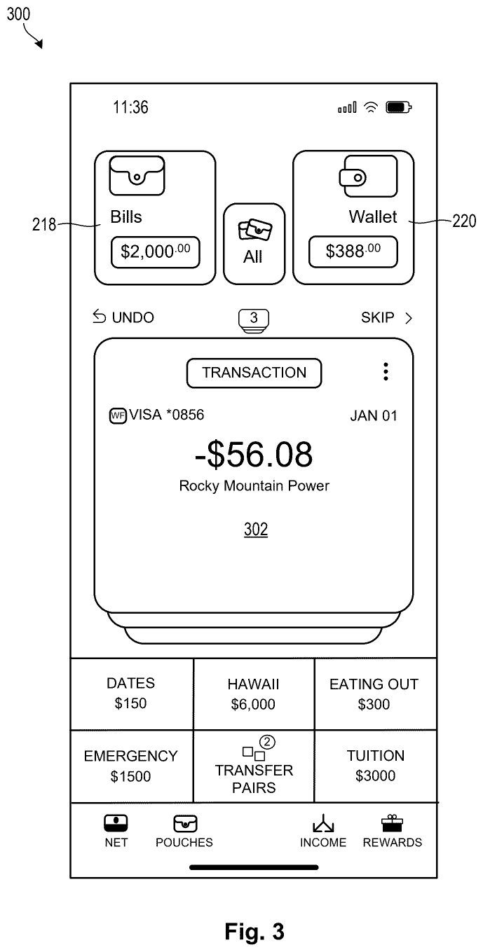

Custom pouches 228, which may also be referred to herein as secondary pouches 228, may be established by the user for different purposes, such as to save or spend for a vacation, dates, eating out, emergency funds, college tuition, of the like. These custom pouches 228 may be used relatively infrequently compared to the primary or core pouches, which may be used for daily living expenses. The core pouches 228 and custom pouches 228 and how they may be used will be discussed in more detail in association with FIGS. 3-8.

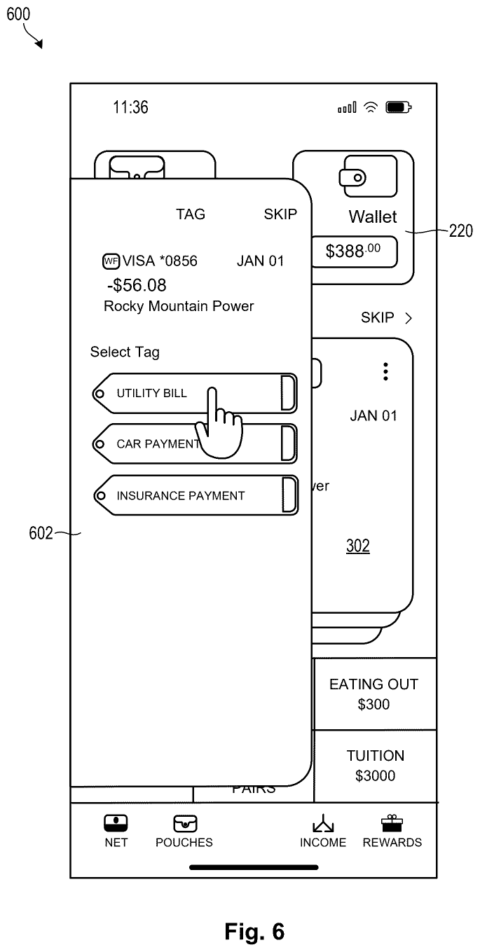

As previously mentioned, in certain embodiments the budgeting module 212 may be configured to establish various sub-pouches within a pouch, such as within the bills pouch 218. In certain embodiments, the tag establishment module 230 may be configured to assist with this function. For example, in certain embodiments, the tag establishment module 230 may be configured to enable a user to tag various expenses allocated to a particular pouch, such as the bills pouch 218. For example, a bill that is allocated to the bills pouch 218 may be tagged as a utility bill, car payment, insurance payment, or the like. Tagging an expense within a pouch 216, 228 may in certain embodiments be deemed equivalent to placing the expense in a sub-pouch within the pouch 216, 228. This concept will be described in more detail in association with FIG. 6.

When income is received by a user, an income splitting module 232 may be used to determine how the income is allocated to the pouches 216, 228. In certain embodiments, when determining how to allocate the income, the income splitting module 232 may utilize an income estimation module 234 to estimate the income of the user. In certain embodiments, this may be accomplished by analyzing past income (past paystubs, pay checks, earnings, distributions, etc.) that the user has received. Alternatively, or additionally, the user may manually enter the user's estimated income into the income estimation module 234.

The income may then be split by the income splitting module 232 into the user's various pouches 216, 228 that have been established. In certain embodiments, the income splitting module 232 may allocate a certain amount of the income “off the top” 236. For example, in certain embodiments, the user may wish to allocate a certain percentage of his or her income off the top to pouches 216, 228 designated for religious contributions or savings such as retirement savings. The pouches 216, 228 for this “off the top” allocation 236 may be designated by the user.

The income splitting module 232 may then allocate income to each of the user's pouches 216, 228 with a priority and in an order 238 designated by the user. These pouches 216, 228 may include the bills pouch 218, wallet pouch 220, and custom pouches 228 designated by the user. In certain embodiments, in this stage, a certain dollar amount may be deducted from the user's income for placement in each of these pouches 216, 228. In certain embodiments, the pouches 216, 228 may be funded from top to bottom starting with the bills pouch 218 and continuing to the last custom pouch 228. If a first paycheck of the user does not fund all of the pouches 216, 228, then a second paycheck of the user may pick up where the first paycheck left off, and so forth. The intent of this ordering is that the most important pouches 216, 228 are funded first each month. Thus, even if a user has an irregular income, the income splitting module 232 may ensure that pouches 216, 228 such as the bills pouch 218 and wallet pouch 220 are funded first based on the designated priority and order 238.

In certain embodiments, the income splitting module 232 may then take any surplus 240 and route it into any designated pouches 216, 228 by percentage. For example, a certain percentage of any surplus 240 may be routed into a vacation pouch and any remaining percentage may be routed into the bills pouch 218 to build up a runway for recurring expenses such as bills. This is just one example of how the surplus 240 may be allocated.

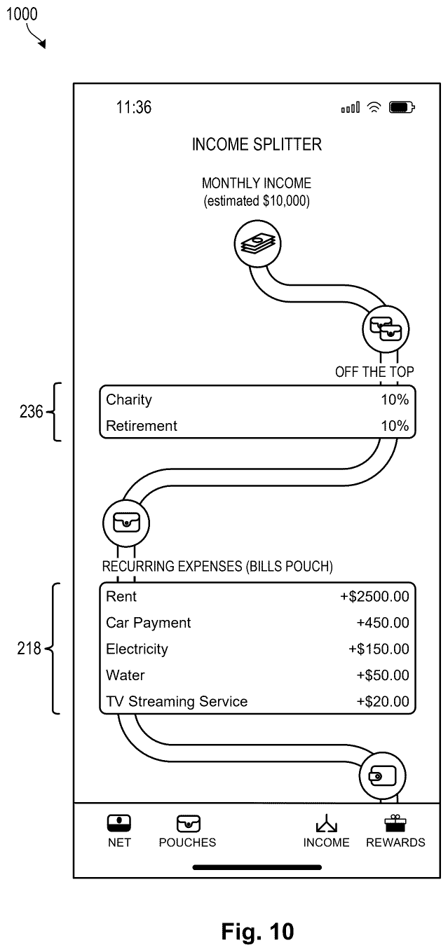

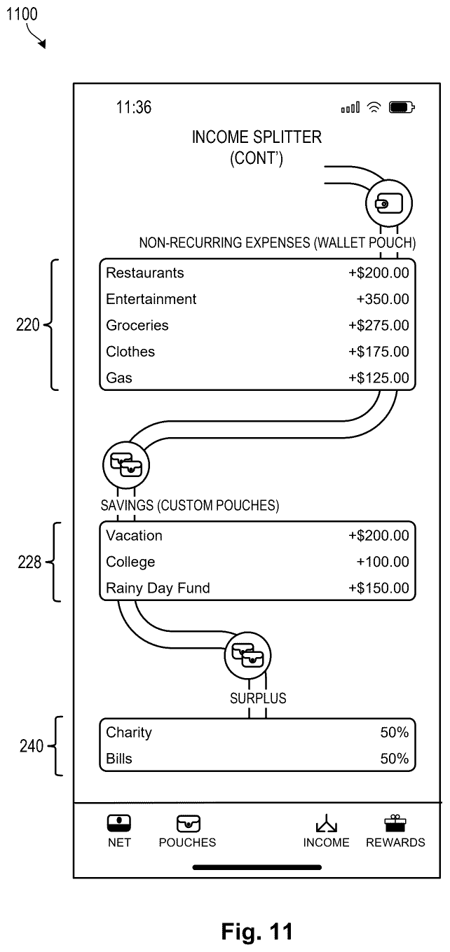

The income splitting module 232 may eliminate or reduce the need for monthly funding sessions found in other budgeting systems. Once the rules are set up for the income splitting module 232, the income splitting module 232 may automatically split up a user's income (e.g., paycheck, etc.) in accordance with the rules. These rules may be modified as needed to align with the user's goals and/or adapt to changes in the user's income. One example of a graphical user interface that may be used to implement the income splitting module 232 will be discussed in association with FIGS. 10 and 11.

The balance presentation module 242 may be used to display a balance for each of the pouches 216, 228. For example, the balance presentation module 242 may display a balance on or in association with the “ready to spend” portion 222 of the wallet pouch 220 that may inform the user of the amount of money that is in the “ready to spend” portion 222. This may help the user to pace his or her spending especially when used in conjunction with the “daily cash” that is allocated to the “ready to spend” portion 222 each day or other selected interval. If the “ready to spend” portion 222 is overdrawn, the balance may show in the negative and/or be highlighted in red or in some other manner. The same manner of presenting balances may also be used with other pouches 216, 228 that the user has established.

The transaction allocation module 244 may be used by a user to allocate transactions (e.g., expenses) to the pouches 216, 228. This may in turn alter the balances in the pouches 216, 228. In certain embodiments, transactions are visually represented as cards that are draggable by a user into the pouches 216, 228 depending on the budget categories to which the transactions are assigned. The transactions may be assigned (e.g., dragged) to pouches 216, 228 and/or tags (i.e., sub-pouches) within the pouches 216, 228. This concept will be discussed in more detail in association with FIGS. 3 through 8. Other techniques for allocating transactions to pouches 216, 228 may be used and are within the scope of the invention.

As previously mentioned, in certain embodiments, in order to pace or regulate spending from the wallet pouch 220 in a way that allows the user's income to last until an end of a designated period (e.g., month), some designated portion of the money in the “in reserve” portion 224 may be periodically transferred to the “ready to spend” portion 222 of the wallet pouch 220. For example, a cash allotment (i.e., “daily cash”) may be transferred daily from the “in reserve” portion 224 to the “ready to spend” portion 222 to provide for the user's daily expenses. The daily cash allocation module 250 may be configured to make this daily transfer from the “in reserve” portion 224 to the “ready to spend” portion 222. In certain embodiments, a user may designate the amount that is transferred or the amount may be automatically calculated such as by dividing up a monthly amount of income designated for non-recurring expenses by a number of days in the month.

In certain cases, a user may wish to manually record a transaction and assign the transaction to a pouch 216, 228 before the transaction has been retrieved from a financial institution (e.g., bank) of the user. In such cases, the user may create a ghost transaction within the financial management module 200 which acts as a placeholder until the actual transaction is retrieved from the financial institution. The ghost transaction module 252 may provide this functionality. The ghost transaction may eventually be automatically matched to a real transaction from the financial institution (if the amount of the ghost transaction and the amount of the transaction from the financial institution match, for example). If no match is found within a certain period of time (e.g., seven days), the expiration module 256 may cause the ghost transaction to expire.

In certain embodiments, a transaction that is pending and assigned to a pouch 216, 228 may change in amount after the transaction has posted. In such cases, the card reprocessing module 254 may update the transaction so that the posted amount is correctly reflected in the pouch 216, 228 to which the transaction was assigned.

On rare occasions bank transaction errors may occur. These may appear as duplicate transactions in information retrieved from financial institutions. In certain embodiments, a deletion module 258 of the financial management module 200 will delete these transactions to show correct balances in the pouches 216, 228. In certain embodiments, in order to keep users informed, the deletion module 258 may present deleted transactions in the card stack, which will be discussed in more detail hereafter.

In certain embodiments, the financial management module 200 disclosed herein may be used by multiple individuals within a family to manage the family's finances. For example, a husband and wife may each use the financial management module 200 to process transactions pertaining to the same budget. In some cases, the family members may have differences in opinion as to which pouches 216, 228 particular transactions should be assigned. In some cases, the family members may actually assign the same transactions to different pouches 216, 228. For example, one family member may believe a transaction should be assigned to the vacations pouch 228 while the other may believe that the transaction should be assigned to the wallet pouch 220.

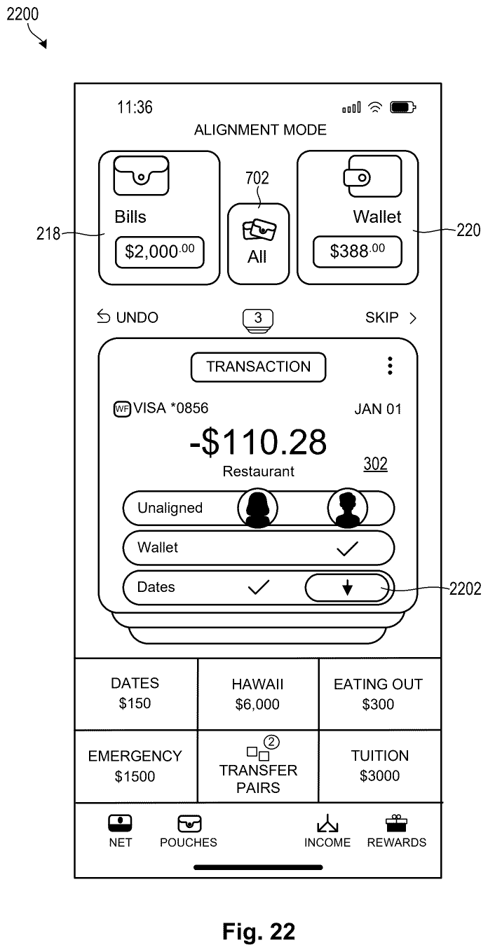

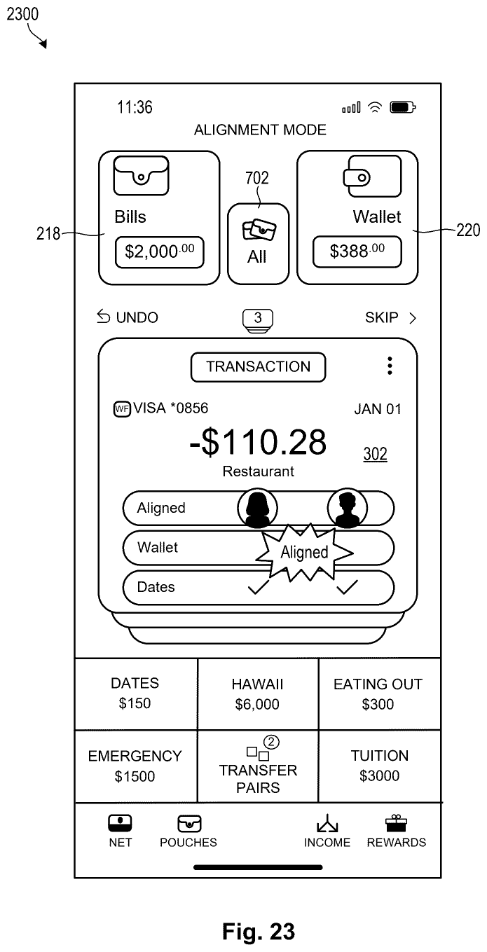

In certain embodiments, an alignment module 260 may be provided to help reconcile any differences in opinion between family members as to which pouches 216, 228 transactions should be assigned. For example, in certain embodiments, the alignment module 260 may enable a user to place the financial management module 200 into “alignment mode” to enable family members to reconcile differences in opinion. For example, placing the financial management module 200 into “alignment mode” may enable one family member to change his or her assignment of a transaction to another pouch 216, 228 to bring the assignment into alignment with another family member. In other cases, the alignment module 260 may inform family members when their decisions align to reinforce areas in which they agree. Examples of a graphical user interface of the financial management module 200 when placed into “alignment mode” will be discussed in association with FIGS. 22 and 23.

In some cases, the financial management module 200 may be configured to assist a user in making wise financial decisions such as paying off debt. For example, utilization of credit cards can be unwise in that they may facilitate overspending as well as burden a user with paying off debt at high interest rates. In many cases, it may be advantageous for the user to pay off and destroy the credit card to help the user obtain better financial habits. In certain embodiments, the liberation module 262 may assist a user in achieving these objectives. For example, in certain embodiments, the liberation module 262 may assist the user in identifying credit cards or other debt instruments that the user could advantageously pay off either immediately or over time to improve the user's financial condition. If the user does utilize a credit card or debt instrument that has been identified for “liberation”, the liberation module 262 may remind the user that this credit card or debt instrument is not to be used and possibly suggest that the user destroy the credit card or debt instrument. In this way, the liberation module 262 may assist a user in paying off debt and obtaining better financial habits.

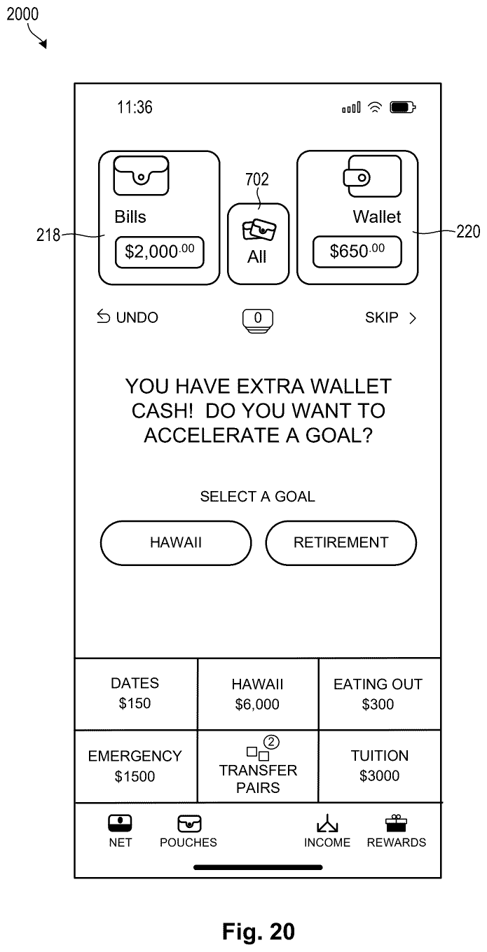

The acceleration module 264 may assist a user in reaching the user's financial goals. For example, if at the end of a specific period (e.g., week, month, year, etc.), the user has excess money in one or more of the user's pouches 216, 228, such as in the user's wallet pouch 220, the acceleration module 264 may query the user if he or she would like to accelerate one of the user's goals, such as saving for a vacation or college tuition. If the user responds in the affirmative, the acceleration module 264 may enable the user to transfer money from the wallet pouch 220 (or another pouch 216, 228) to a pouch designated for vacations or college tuition. One example of a graphical user interface or screen showing how this may work will be discussed in association with FIG. 20.

Referring to FIG. 3, as previously mentioned, the transaction allocation module 244 may be used by a user to allocate transactions (e.g., expenses) to the pouches 216, 228. For example, as shown in FIG. 3, in certain embodiments, transactions are visually represented as cards 302 in a card stack that are draggable by a user into the pouches 216, 228 depending on the budget categories to which the user believes the transactions should be assigned.

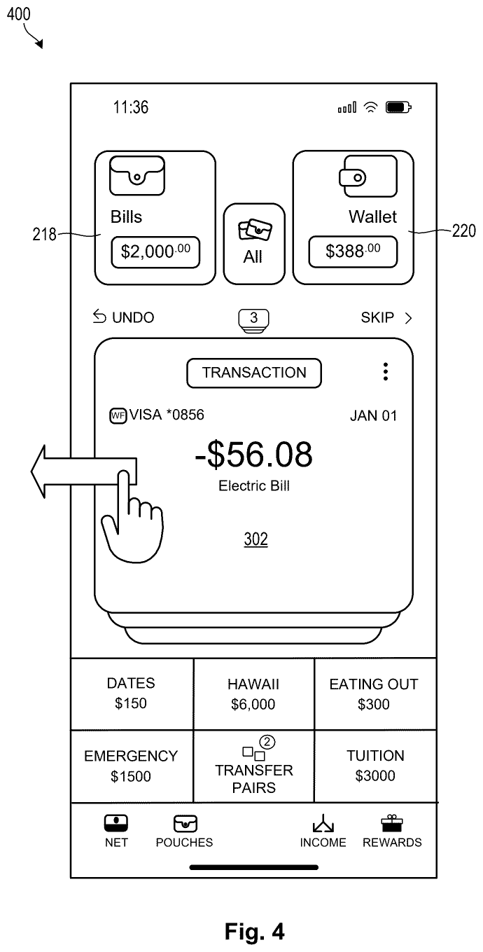

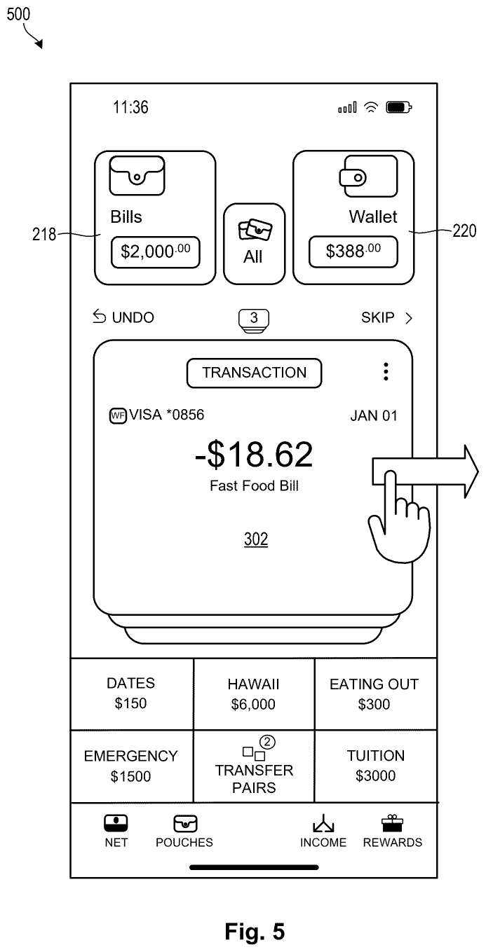

In the illustrated graphical user interface 300, the core pouches 216 (i.e., the bills pouch 218 and the wallet pouch 220, namely the “ready to spend” portion 222 of the wallet pouch 220) are illustrated. In most cases, a transaction represented by a card 300 will be dragged into one of these core pouches 216 since most transactions will either be recurring (e.g., monthly) expenses or day-to-day (i.e., non-recurring) living expenses. Thus, in most cases, a user is presented with a binary choice between the bills pouch 218 and the wallet pouch 220 in which to swipe a card 300. In certain embodiments, a swipe in a first direction (e.g., to the left) may assign the transaction to the bills pouch 218, as shown in the graphical user interface 400 of FIG. 4. Similarly, a swipe in a second direction (e.g., to the right) may assign the transaction to the wallet pouch 220, as shown in the graphical user interface 500 of FIG. 5. This may greatly simplify the budgeting process since it may reduce the large number of choices or categories, frequently provided by other budgeting and financial management software, to a binary choice to which to assign a transaction.

Referring to FIG. 6, in certain embodiments, pouches 216, 228 such as the bills pouch 218 may be configurable to include sub-pouches that define different categories at a more granular level. For example, the tag establishment module 230 previously discussed may be configured to assist with this function. For example, in certain embodiments, the tag establishment module 230 may be configured to enable a user to tag various expenses allocated to a particular pouch, such as the bills pouch 218. As an example, a bill that is allocated to the bills pouch 218 may be tagged as a utility bill, a car payment, an insurance payment, or the like. Tagging an expense within a pouch 216, 228 may in certain embodiments be deemed equivalent to placing the expense in a sub-pouch within the pouch 216, 228. The graphical user interface 600 of FIG. 6 shows various examples of sub-pouches into which a transaction may be swiped. For example, when a card 302 representing a transaction is swiped to the left into the bills pouch 218, a panel 602 may optionally appear which may enable the user to further define what tag or sub-pouch to which to assign the transaction.

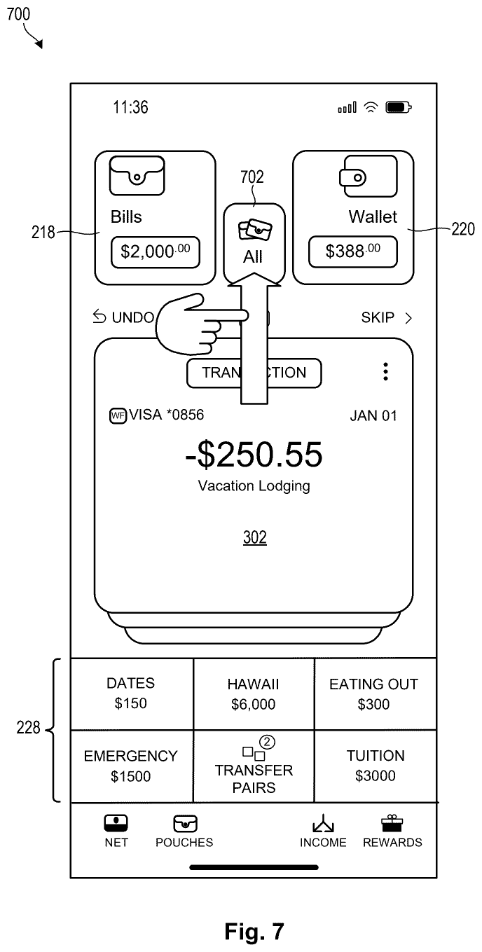

Referring to FIG. 7, as previously mentioned, in most cases, a user is presented with a binary choice between the bills pouch 218 and the wallet pouch 220 in which to swipe a card 300. However, in less frequent cases, the user may wish to assign a transaction to a custom pouch 228. As previously mentioned, custom pouches 228 may be established by the user for different purposes, such as to save or spend for a vacation, dates, eating out, emergency funds, college tuition, of the like. These custom pouches 228 may be used infrequently compared to the core pouches 216 such as the bills pouch 218 and wallet pouch 220.

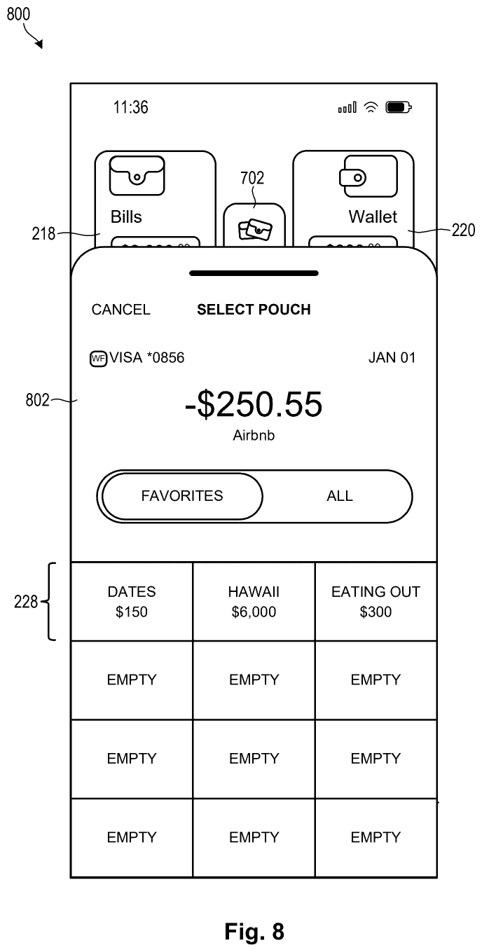

Transactions may be assigned to custom pouches 228 in various different ways. For example, in one embodiment, a card 302 representing a transaction may be dragged upward to a custom pouch emblem 702, as shown in the graphical user interface 700 of FIG. 7. This may in turn reveal a list 802 or panel 802 of some or all of the custom pouches 228, as shown in the graphical user interface 800 of FIG. 8. One of these custom pouches 228 may be selected to assign the transaction to the associated custom pouch 228. Alternatively, or additionally, the custom pouches 228 may be displayed on the graphical user interface 700 and the transaction may be dragged or otherwise assigned to these custom pouches 228 by dragging, swiping, etc. to assign the transaction to the associated custom pouch 228.

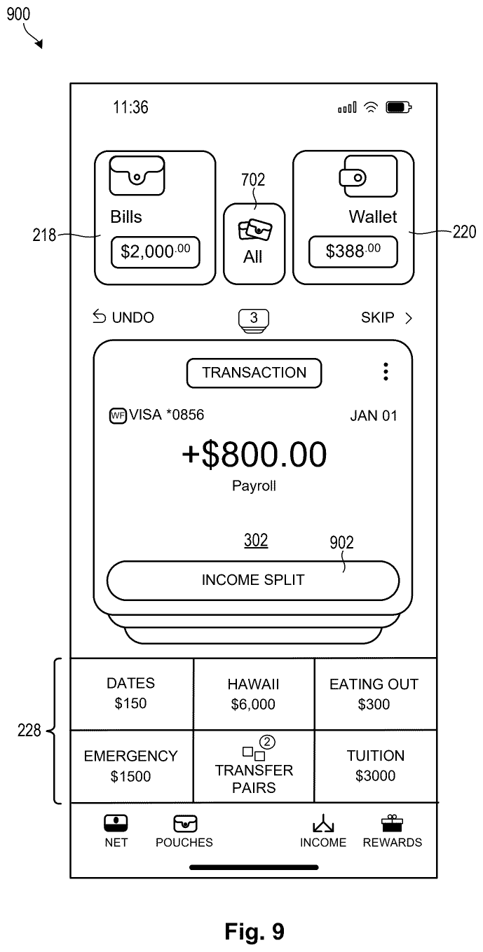

Referring to FIG. 9, as previously mentioned, when income is received into the pouches 216, 228, an income splitting module 232 may be used to determine how the income is allocated to the pouches 216, 228. FIG. 9 shows one example of a card 302 that represents income (i.e., payroll) for allocation to the pouches 216, 228 in accordance with a formula of the income splitting module 232. This formula may be configured by the user. As shown, when income is received, the user may, in certain embodiments, select an “income split” button 902 or other functionality to invoke operation of the income splitting module 232. Other methods or techniques for invoking operation of the income splitting module 232 are possible and within the scope of the invention.

This income may then be split by the income splitting module 232 into the user's various pouches 216, 228 that the user has established, as shown in the graphical user interfaces 1000, 1100 of FIGS. 10 and 11. In certain embodiments, the income splitting module 232 may allocate a certain amount of the income “off the top” 236. For example, in certain embodiments, the user may wish to allocate a certain percentage of his or her income off the top to pouches 216, 228 designated for charity or savings such as retirement savings. The pouches 216, 228 for this “off the top” allocation 236 may be designated by the user when configuring the income splitting module 232.

The income splitting module 232 may then allocate to each of the user's pouches 216, 228 with a priority and in an order 238 designated by the user. These pouches 216, 228 may include the bills pouch 218, wallet pouch 220, and custom pouches 228 designated by the user. In certain embodiments, in this stage, a certain dollar amount may be deducted from the user's income for placement in each of these pouches 216, 228. In certain embodiments, the pouches 216, 228 may be funded from top to bottom starting with the bills pouch 218 and continuing to the last custom pouch 228. If a first paycheck of the user does not fund all of the pouches 216, 228, then a second paycheck of the user may pick up where the first paycheck left off, and so forth. The intent of this ordering is that the most important pouches 216, 228 may be funded first each month. Thus, even if a user has an irregular income, the income splitting module 232 may ensure that pouches 216, 228 such as the bills pouch 218 and wallet pouch 220 are funded first based on the designated order.

In certain embodiments, the income splitting module 232 may then take any surplus 240 and route it to any designated pouches 216, 228 by percentage. For example, a certain percentage of any surplus 240 may be routed into a charity pouch and any remaining percentage may be routed into the bills pouch 218 to build up a runway for recurring expenses such as bills. This is just one example of how the surplus 240 may be allocated and is not intended to be limiting.

Referring to FIG. 12, in certain embodiments, the financial management module 200 may provide a page 1200 or graphical user interface 1200 dedicated to showing a user's net worth. In certain embodiments, this net worth may be calculated using the user's on-budget accounts 204 and off-budget accounts 206.

Similarly, in certain embodiments, the financial management module 200 may provide a page 1200 or graphical user interface 1200 showing the user's wallet pouch 220, including the “ready to spend” portion 222 and “in reserve” portion 224 of the wallet pouch 220. In certain embodiments, this page 1200 or graphical user interface 1200 may show the daily cash allotment (i.e., “daily cash”) that is transferred from the “in reserve” portion 224 to the “ready to spend” portion 222 to provide for the user's daily expenses, as well as enable a user to configure this amount if desired. In certain embodiments, the page 1200 or graphical user interface 1200 shows a “runway” for the wallet pouch 220, which may indicate how long the balance in the wallet pouch 220 may last before it is depleted at the user's current spending rate (e.g., possibly calculated from the “daily cash” allotment).

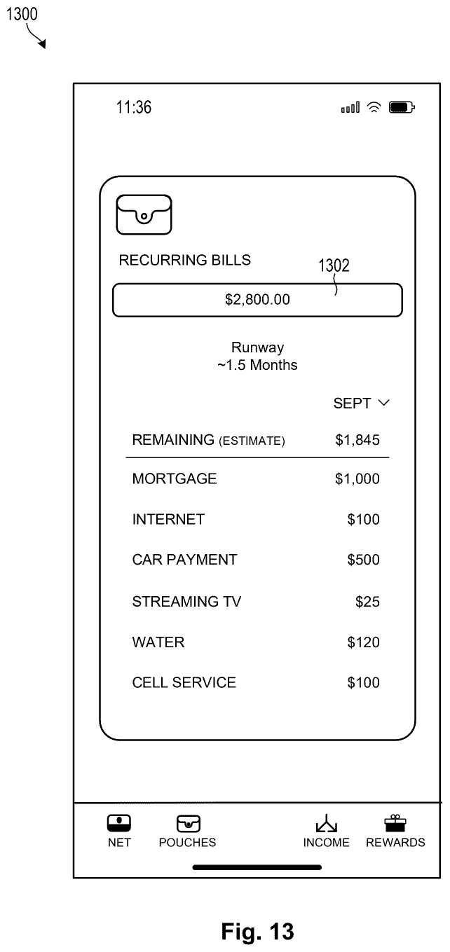

Referring to FIG. 13, in certain embodiments, the financial management module 200 may provide a page 1300 or graphical user interface 1300 showing the user's recurring bills and the current balance 1302 in the user's bills pouch 218. Using this information, the financial management module 200 may calculate a runway for the balance in the bills pouch 218, which may indicate how long the current balance in the bills pouch 218 will last before it is depleted based on the user's recurring bills.

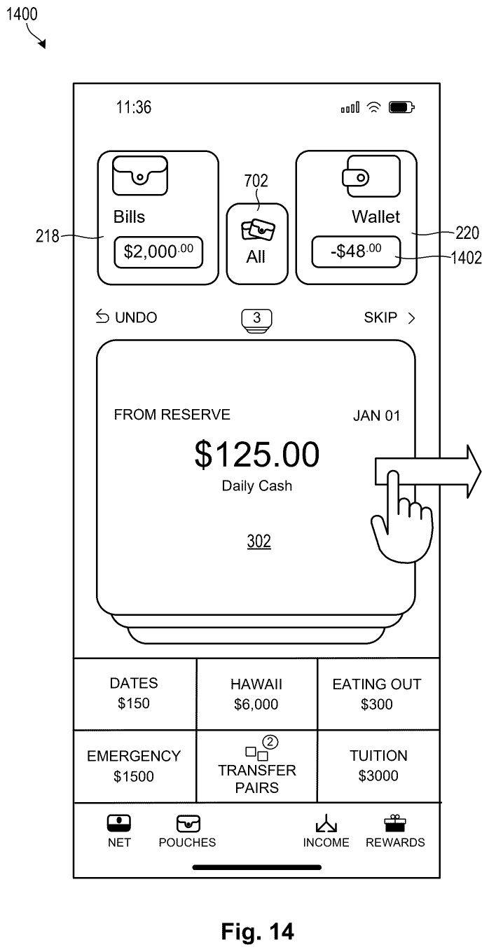

Referring to FIG. 14, in certain embodiments, a card 302 representing “daily cash” may be presented to the user each day as shown in the page 1400 or graphical user interface 1400 shown in FIG. 14. The user may swipe right on this card 302 or in a direction associated with the user's wallet pouch 220 to transfer this “daily cash” from the “in reserve” portion 224 to the “ready to spend” portion 222 of the user's wallet pouch 220. The balance 1402 associated with the user's wallet pouch 220 may be increased accordingly to indicate how much money the user has in the “ready to spend” portion 222 of the user's wallet pouch 220.

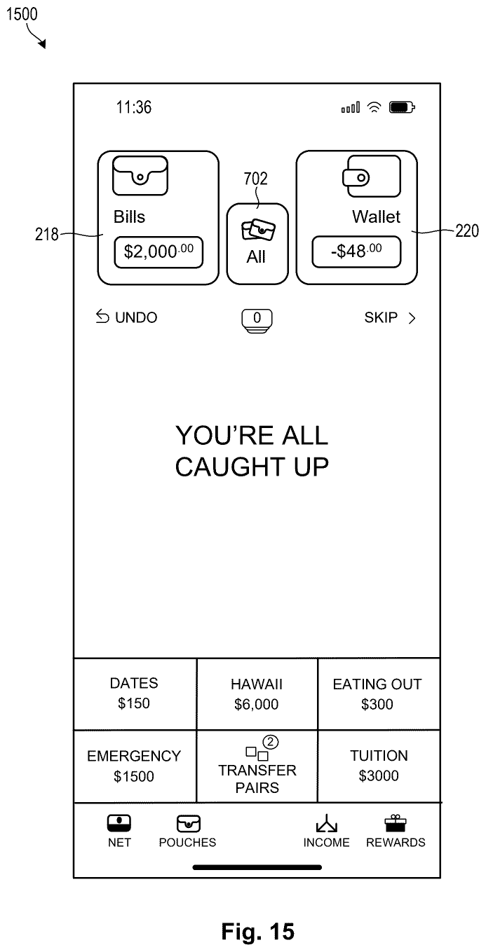

Referring to FIG. 15, in certain embodiments, once a user has swiped or otherwise addressed all of the cards 302 in the stack, a page 1500 or graphical user interface 1500 may indicate that the user is “all caught up” or provide another similar message to indicate that there is no current work in the stack. As new transactions, income, or other work items come up, new cards 302 may appear on the stack for handling by the user.

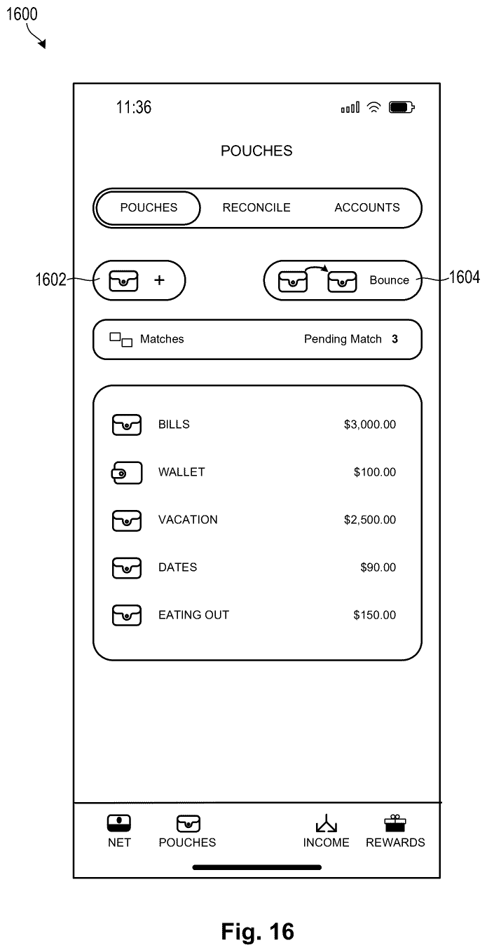

Referring to FIG. 16, in certain embodiments, the financial management module 200 may provide a page 1600 or graphical user interface 1600 showing the user's pouches 216, 228 and the balances contained therein. This page 1600 or graphical user interface 1600 may enable the user to add 1602 new pouches 216, 228 or delete or modify existing pouches 216, 228. In certain embodiments, a “bounce” option 1604 may enable money to be transferred between the pouches 216, 228. The term “bounce” may be used in certain embodiments to prevent confusion with a bank transfer and to indicate that no money is actually being transferred between the user's accounts.

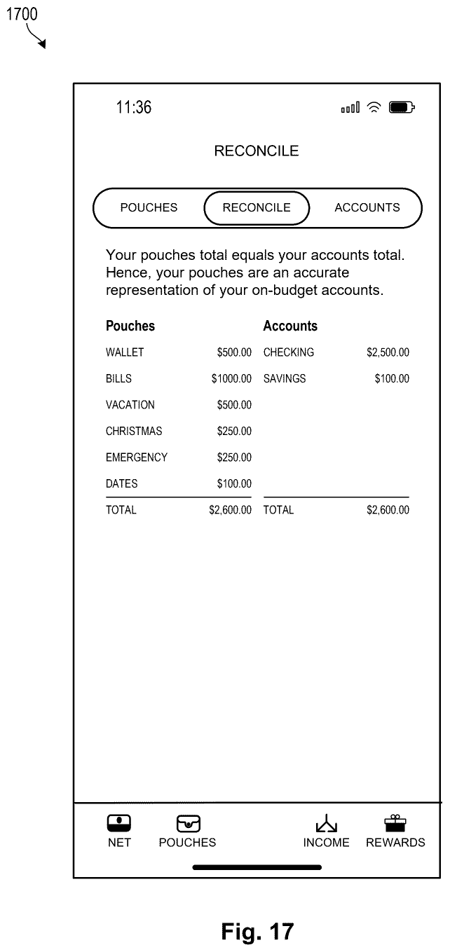

Referring to FIG. 17, in certain embodiments, the financial management module 200 may provide a page 1700 or graphical user interface 1700 to enable the user to reconcile the balances in the user's pouches 216, 228 with the balances in the user's accounts. Ideally, the sum of the balances of the pouches 216, 228 and the sum of the balances of the accounts will be equal but if they are not this page 1700 or graphical user interface 1700 may enable the user to identify any discrepancies and make appropriate corrections, such as by adjusting the balances in the user's pouches 216, 228 to correspond to the amounts in the accounts.

Referring to FIG. 18, as previously mentioned, in certain embodiments, cards 302 representing pending transactions may be assigned to the pouches 216, 228. However, in certain cases, a transaction that is pending and assigned to a pouch 216, 228 may have a different amount when the transaction has posted. In such cases, a card 302 may be presented to the user that shows the updated posted transaction with an amount that differs from the corresponding pending transaction, as shown by the page 1800 or graphical user interface 1800 of FIG. 18. In this example, the card 302 includes an option 1802 to assign the difference in the posted and pending amounts to one of the user's pouches 216, 228 so that the balances in the user's pouches 216, 228 and the user's accounts stay consistent with one another.

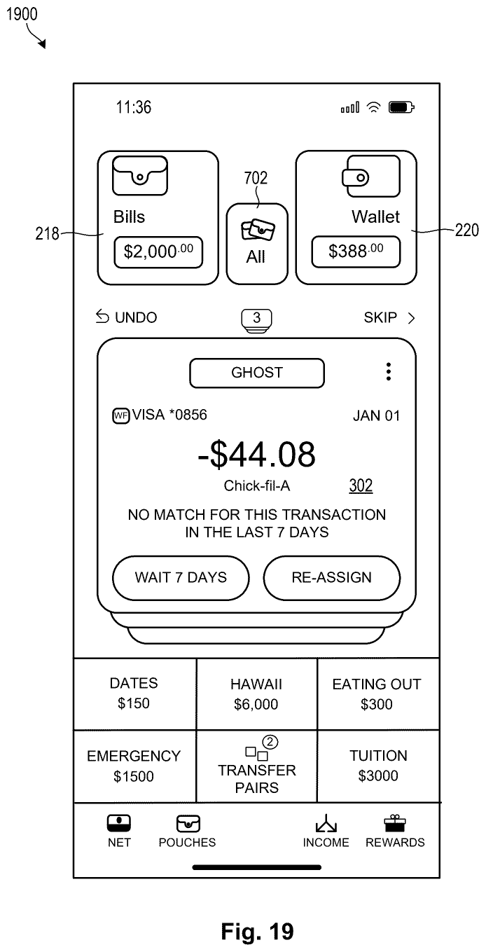

Referring to FIG. 19, as previously mentioned, in certain cases, a user may wish to manually record a transaction and assign the transaction to a pouch 216, 228 before the transaction has been retrieved by the financial management module 200 from a financial institution (e.g., bank) of the user. In such cases, the user may create a ghost transaction within the financial management module 200 which acts as a placeholder until the actual transaction is retrieved from the financial institution. The ghost transaction module 252 may provide this functionality. In certain embodiments, the ghost transaction may be presented as a card 302 that can be swiped into one of the user pouches 216, 228. The ghost transaction may eventually be automatically matched to a real transaction from the financial institution (if the amounts of the transactions match, for example). If no match is found within a certain period of time (e.g., seven days), the card 302 may be re-presented as shown by the page 1900 or graphical user interface 1900 of FIG. 19 and the expiration module 256 may cause the ghost transaction to expire.

Referring to FIG. 20, as previously mentioned, the acceleration module 264 may assist a user in reaching various of the user's goals. For example, if at the end of a specific period (e.g., week, month, year, etc.), the user has excess money in one or more of the user's pouches 216, 228, such as in the user's wallet pouch 220, the acceleration module 264 may query the user if he or she would like to accelerate one of the user's goals, such as saving for a vacation or college tuition. If the user responds in the affirmative, the acceleration module 264 may enable the user to transfer money from the wallet pouch 220 (or another pouch 216, 228) to a pouch designated for a goal such as a vacation or retirement, as shown in the page 2000 or graphical user interface 2000 of FIG. 20.

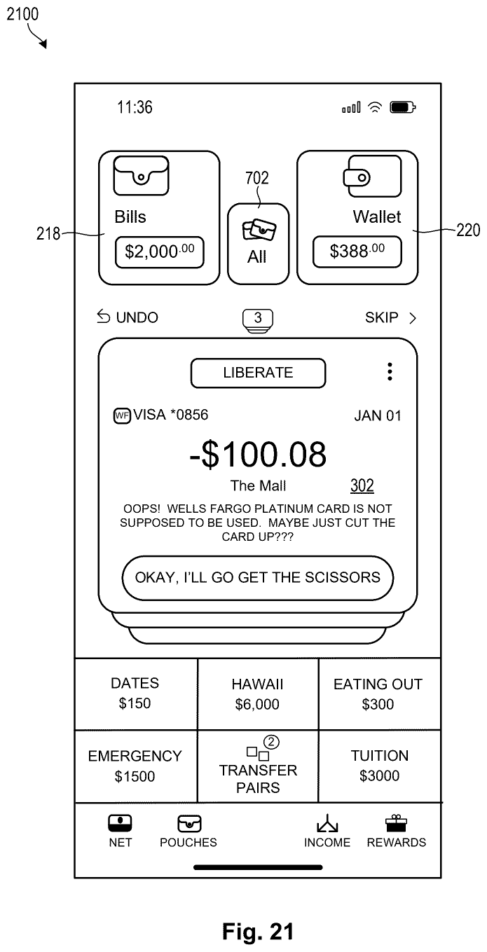

Referring to FIG. 21, as previously mentioned, in certain cases, the financial management module 200 may be configured to assist a user in making wise financial decisions such as paying off debt. In certain embodiments, the liberation module 262 may assist a user in achieving these objectives. For example, in certain embodiments, the liberation module 262 may assist the user in identifying credit cards or other debt instruments that the user could advantageously pay off either immediately or over time to improve the user's financial condition. If the user does utilize a credit card or debt instrument that has been identified for “liberation”, the liberation module 262 may remind the user (such as with the card 302) that this credit card or debt instrument is not to be used and possibly suggest that the user destroy the credit card or debt instrument as shown in the page 2100 or graphical user interface 2100 of FIG. 21.

Referring to FIGS. 22 and 23, as previously mentioned, the alignment module 260 may be provided to help reconcile any differences in opinion between family members as to which pouches 216, 228 transactions should be assigned. For example, in certain embodiments, the alignment module 260 may enable a user to place the financial management module 200 into “alignment mode” to enable family members to reconcile differences in opinion. For example, placing the financial management module 200 into “alignment mode” may enable one family member to change his or her assignment of a transaction to another pouch 216, 228 to bring the assignment into alignment with another family member, as shown by the page 2200 or graphical user interface 2200 of FIG. 22. In this example, one family member has assigned a transaction to the wallet pouch 220 and the other family member has assigned the transaction to the “dates” custom pouch 228. The page 2200 or graphical user interface 2200 may enable one family member to bring his or her assignment into alignment with the other family member by selecting the option 2202. In the event the user selects this option 2202, the alignment module 260 may inform family members when their decisions align to reinforce areas in which they agree, as shown by the page 2300 or graphical user interface 2300 of FIG. 23.

In the above disclosure, reference has been made to the accompanying drawings which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” an “example,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While various embodiments of the present disclosure have been described above, it should be understood that they have been presented by way of example only and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teachings. Further, it should be noted that any or all of the aforementioned alternate implementations may be used in any combination desired to form additional hybrid implementations of the disclosure.

1. A method to assist an individual or family in managing finances, the method comprising:
documenting a plurality of financial transactions associated with a user;
establishing a plurality of budget categories to which the financial transactions may be assigned;
representing, on a graphical user interface, the financial transactions as a plurality of cards that are draggable by the user in a desired direction;
representing, on the graphical user interface, the budget categories as a plurality of virtual pouches; and
enabling the user to drag the cards into the virtual pouches to assign the associated financial transactions to the associated budget categories.

2. The method of claim 1, wherein a first primary pouch of the virtual pouches is configured to receive cards documenting fixed recurring expenses.

3. The method of claim 1, wherein a second primary pouch of the virtual pouches is configured to receive cards documenting variable non-recurring expenses.

4. The method of claim 2, wherein the first primary pouch displays a balance that is decreased each time a card representing a fixed recurring expense is received therein.

5. The method of claim 3, wherein the second primary pouch displays a balance that is decreased each time a card representing a variable non-recurring expense is received therein.

6. The method of claim 3, wherein the second primary pouch displays a “ready to spend” balance that is increased each time a periodic allocation of income is received therein.

7. The method of claim 6, wherein the periodic allocation is a daily recurring allocation.

8. A computer program product to assist an individual or family in managing finances, the computer program product comprising a computer-readable storage medium having computer-usable program code embodied therein, the computer-usable program code configured to perform the following when executed by at least one processor:
document a plurality of financial transactions associated with a user;
establish a plurality of budget categories to which the financial transactions may be assigned;
represent, on a graphical user interface, the financial transactions as a plurality of cards that are draggable by the user in a desired direction;
represent, on the graphical user interface, the budget categories as a plurality of virtual pouches; and
enable the user to drag the cards into the virtual pouches to assign the associated financial transactions to the associated budget categories.

9. The computer program product of claim 8, wherein a first primary pouch of the virtual pouches is configured to receive cards documenting fixed recurring expenses.

10. The computer program product of claim 8, wherein a second primary pouch of the virtual pouches is configured to receive cards documenting variable non-recurring expenses.

11. The computer program product of claim 9, wherein the first primary pouch displays a balance that is decreased each time a card representing a fixed recurring expense is received therein.

12. The computer program product of claim 10, wherein the second primary pouch displays a balance that is decreased each time a card representing a variable non-recurring expense is received therein.

13. The computer program product of claim 10, wherein the second primary pouch displays a “ready to spend” balance that is increased each time a periodic allocation of income is received therein.

14. The computer program product of claim 13, wherein the periodic allocation is a daily recurring allocation.

15. A system to assist an individual or family in managing finances, the system comprising:
at least one processor;
at least one memory device operably coupled to the at least one processor and storing instructions for execution on the at least one processor, the instructions causing the at least one processor to:
document a plurality of financial transactions associated with a user;
establish a plurality of budget categories to which the financial transactions may be assigned;
represent, on a graphical user interface, the financial transactions as a plurality of cards that are draggable by the user in a desired direction;
represent, on the graphical user interface, the budget categories as a plurality of virtual pouches; and
enable the user to drag the cards into the virtual pouches to assign the associated financial transactions to the associated budget categories.

16. The system of claim 15, wherein a first primary pouch of the virtual pouches is configured to receive cards documenting fixed recurring expenses.

17. The system of claim 15, wherein a second primary pouch of the virtual pouches is configured to receive cards documenting variable non-recurring expenses.

18. The system of claim 16, wherein the first primary pouch displays a balance that is decreased each time a card representing a fixed recurring expense is received therein.

19. The system of claim 17, wherein the second primary pouch displays a balance that is decreased each time a card representing a variable non-recurring expense is received therein.

20. The system of claim 17, wherein the second primary pouch displays a “ready to spend” balance that is increased each time a periodic allocation of income is received therein, wherein the periodic allocation is a daily recurring allocation.
